(19) United States
(12) Patent Application Publication
(10) Pub. No.: US 2004/0225883 A1
(43) Pub. Date: Nov. 11, 2004

(54) Method and apparatus providing multiple single levels of security for distributed processing in communication systems

(76) Inventors: Michael K. Weller, Stroudsburg, PA (US); Jeffrey B. Canter, West Orange, NJ (US); Michael A. Pizzirusso, Budd Lake, NJ (US); Fabrizio Rontanini, Fair Lawn, NJ (US)

Correspondence Address: DAVID L. DAVIS, ESQ., 90 WASHINGTON VALLEY ROAD, BEDMINSTER, NJ, 07921, US

(21) Appl. No.: 10/837,790

(22) Filed: May 3, 2004

Related U.S. Application Data
(60) Provisional application No. 60/469,322, filed on May 7, 2003.

(51) Int. Cl. H04L 9/00

(52) U.S. Cl. 713/166

(57) ABSTRACT

A method for operating a multiple single levels of security (MSLS) system comprising the step of providing switched-circuit functionality between channels operating at the same level of security whereby MSLS requirements are met and intelligence is distributed in a way to minimize security certification effort, and apparatus operative for said method.

### CROSS-REFERENCE TO RELATED APPLICATION

The present application claims the benefit of Provisional Application Ser. No. 60/469,322 filed May 7, 2003, and entitled “Hardware Enforced Multiple Single Levels of Security For Distributed Processing.” The contents of that application are hereby incorporated by reference.

### FIELD OF THE INVENTION

The present invention relates generally to security systems for use in communication systems, and more particularly to such security systems that include Multiple Single Levels of Security (MSLS).

### BACKGROUND OF THE INVENTION

Present communication systems, typically bidirectional communication systems, whether for military, industrial or commercial use, or for use between private individuals, typically require separate physical systems for each security level supported. The requirements depend upon the types of information being communicated, and upon the parties involved in the communication.

Different levels of security are defined in DOD 5200.28-STD, entitled “Department Of Defense Trusted Computer System Evaluation Criteria,” dated December 1985. In broad terms, the criteria are characterized by four divisions, namely “A, B, C, and D”. Division A is the highest protection, and is known as “Verified Protection.” The next level is “Division B: Mandatory Protection”; followed by “Division C: Discretionary Protection”; followed by the lowest level “Division D: Minimal Protection.” DOD5200.28-STD also provides the mandatory access control requirements for these levels of security.

Particularly in the military fields, including the armed forces and DOD, and governmental agencies such as NASA, and many others, hierarchical mandatory access control is required. Similarly, hospitals and commercial companies, for example, may require non-hierarchical mandatory access control to be maintained for their information or material.

One example of military use for Multiple Single Levels of Security (MSLS) is in Joint Tactical Radio Systems, known under the acronym JTRS. The present inventors recognize that known MSLS systems require involved security certifications, and typically have inadequate networking capability. Accordingly, the present inventors recognize that there is a need in the art for providing an MSLS system capable of meeting all of the security requirements of such systems, in addition to permitting the distribution of intelligence or secure information or material in a manner minimizing security certification efforts, while providing networking functionality between channels operating with the same security label. They further recognize that there is a present need for such MSLS records and apparatus not only for JTRS systems, but also for use in any applicable communication systems requiring MSLS.

### SUMMARY OF THE INVENTION

In one embodiment of the present invention a software defined JTRS radio system is provided that satisfies MSLS security requirements, by including means for permitting multiple channels to be utilized. Each channel is capable of operating with a different security label from all other channels in a manner minimizing security certification efforts between users of the JTRS radio systems. Another embodiment of the invention includes networking means for providing functionality or communication between channels operating with the same security label. In yet another embodiment of the invention, a system and method is provided for permitting multiple apparatus having a plurality of ports and/or channels to communicate via connection only of respective ports and/or channels having the same security label.

### BRIEF DESCRIPTION OF THE DRAWINGS

Various embodiments of the invention are described in detail below with reference to the drawings, in which like items are identified by the same reference designation, wherein:

FIG. 1 is a functional block diagram showing one embodiment of the present invention;

FIG. 2 is a functional block diagram showing details of a preferred embodiment of the method and apparatus of the present invention;

FIG. 3 is a functional block diagram of various embodiments of the invention shown, for example, as used in a JTRS system or environment;

FIG. 4 shows a Switch Policy (SP) Startup Sequence Diagram for an embodiment of the invention;

FIG. 5 shows an I/O Port Classification Data Sequence Diagram for an embodiment of the invention;

FIGS. 6A and 6B together show a Circuit Connection Request Sequence Diagram for an embodiment of the invention;

FIGS. 7A and 7B together show a Circuit Disconnect Request Sequence Diagram for an embodiment of the invention; 96642 3

FIGS. 8A and 8B together show a Processor Security label Change Sequence Diagram for an embodiment of the invention; and

FIGS. 9A and 9B together show a Reset SP Sequence Diagram for an embodiment of the invention.

### DETAILED DESCRIPTION

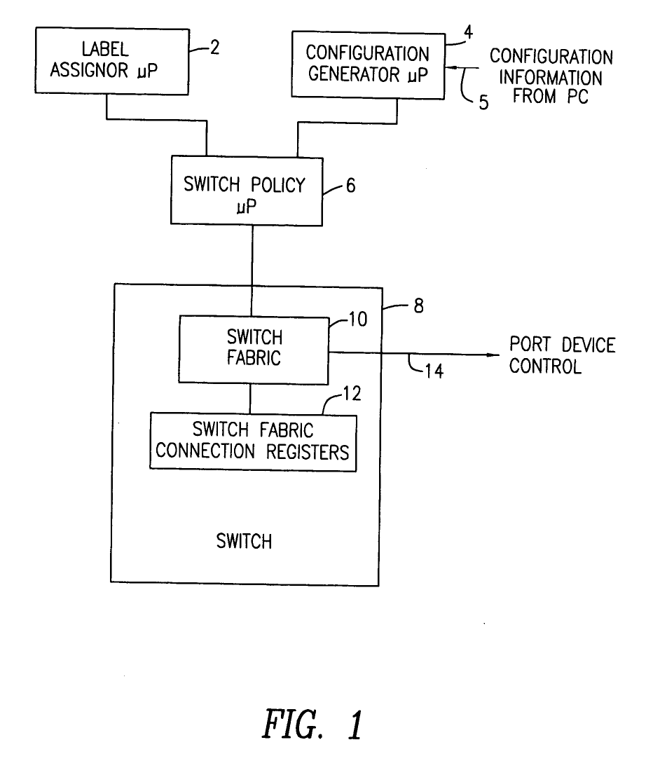

One use of the various embodiments of the invention is illustrated in FIG. 1, showing a block schematic diagram of a Joint Tactical Radio System (JTRS) that includes multiple single levels of security (MSLS) by inclusion of the present invention. Before describing various aspects of the system of FIG. 1, as previously indicated, although the present invention is illustrated as used in a JTRS, it is not meant to be so limited, and can be used or incorporated into hospital record systems, any myriad number of commercial data processing or information systems, such as used by insurance companies, or by educational institutions, and so forth. Throughout this description of the invention, the term “Switch” is associated with switches that respectively provide different levels of security. As will be shown, the present invention provides for the physical separation of security labels, for ensuring the obtainment of multiple single levels of security (MSLS), also known as multiple independent levels of security (MILS). Through use of the present invention's switch policy programming (SP), controlling the operation of the Switch, required security policy for the system is enforced, whereby at any given time only ports and/or channels having the same security label can be connected together. Typically, the Switch device itself is provided by an application specific integrated circuit (ASIC).

With reference to FIG. 1, a generalized functional block diagram of one embodiment of the invention is shown. More specifically, a label assignor 2, consisting of a microprocessor in this example, is programmed to assign specific security labels to ports and channels that are available in the system being controlled. Another microprocessor is programmed to provide a configuration generator 4 for providing connection information, such as which ports, and the specific port configurations, are to be connected to various channels, for example. In other words, the configuration generator 4 provides instructions for making all interconnections between ports and channels, and/or between channels.

The label assignor 2 and configuration generator 4 are each connected to a switch policy (SP) microprocessor 6. Switch policy microprocessor 6 is programmed to compare the security labels assigned to various ports and channels with the interconnection request received from the configuration generator 4, to ensure that for any of the interconnection requests, that only ports and channels having the same security label are approved for interconnection. Switch policy microprocessor 6 enforces both hierarchical and non-hierarchical mandatory access control decisions. Note that the switch policy microprocessor 6 is programmed to make a one-to-one association between labels from the label assignor 2 and port and channel interconnections from the configuration generator 4. If the security labels are not identical for any of the connections being requested, the switch policy microprocessor 6 is programmed to send a return response to the configuration generator 4, whereby the connections will not be made or permitted. Otherwise, the switch policy microprocessor 6 will drive the switch 8 to make the requested port and/or channel interconnections. The switch 8 includes switch fabric connection registers 12. The switch fabric connection registers 12 receive the interconnection information from the switch policy microprocessor 6, resetting the associated registers (not shown) to in turn cause the switch fabric connections to be made, that is, to connect the requested ports and channels together as requested, and as approved by the switch policy 6.

In the example of use of the present invention in a joint tactical radio system (JTRS), the switch fabric connection registers 12 are included in the JTRS. However, an external device may also be connected to the JTRS, in which case the switch connection registers 12 will provide control signals over control line 14 for controlling the switch fabric connection registers 12 of the external device, for example. Note that the control signal output line 14 does not necessarily represent a hardwire connection, and can be a connection made via an infrared coupling or via radio transmission, for example. Also note that the configuration generator 4 can typically be configured from a personal computer, as shown by control line 5, for example. Also, a typical implementation may include four processors, four channels, and an associated switch 8, for example.

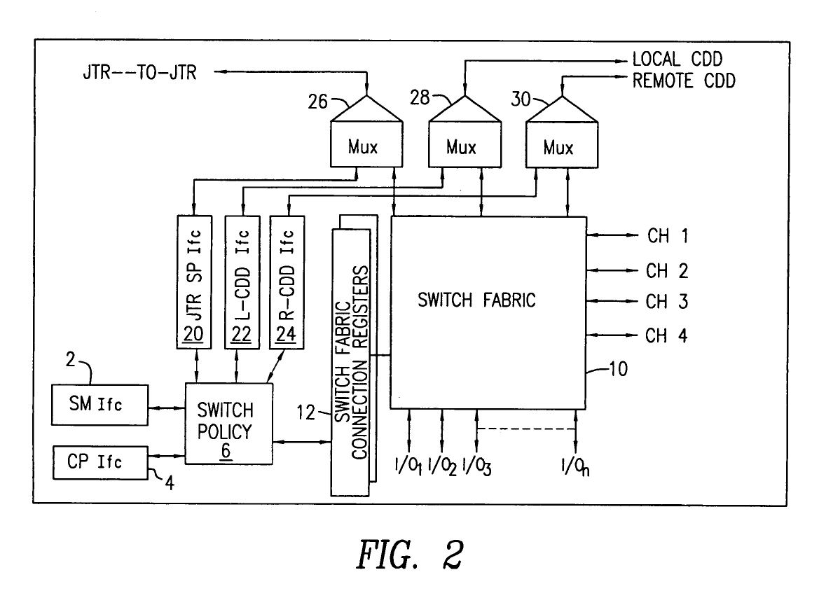

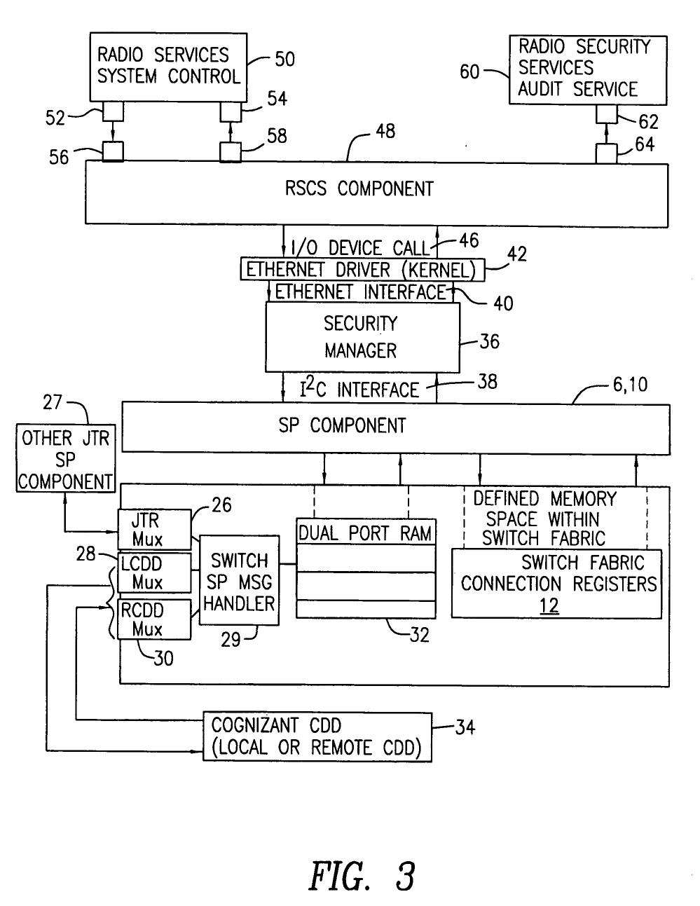

Use of a multiple single levels of security system of the present invention in a Joint Tactical Radio System (JTRS) is shown in FIG. 2 with one level of detail, and in FIG. 3 with a higher level of detail. The Joint Tactical Radio System (JTRS) uses physical isolation, the aforesaid Switch Policy 6 functioning in conjunction with the switch 8 to enforce a mandatory access control (MAC) policy for multiple single levels of security (MSLS). The various limits subject to MAC include the Input/Output (I/O) ports I/O₁ through I/Oₙ, and channels CH1 through CH4, of the Switch fabric connection registers 12, as shown in FIG. 2, as an example. Through use of MAC, the necessary label requirements are provided by the label assignor 2 (FIG. 1) and the MSLS requirement is supported. The switch 8 supports interconnections between various combinations of the I/O ports and Processor interfaces. With further reference to FIGS. 1 and 2, the switch policy microprocessor 6 is connected to the label assignor microprocessor 2, and configuration generator microprocessor 4, previously mentioned.

A Security Manager (SM) 36 bidirectionally communicates with the SP component 6,10. The Security Manager 36, in this example, bidirectionally communicates via a local area network or Ethernet interface 40 with an Ethernet driver 42. The Ethernet driver 42 bidirectionally communicates through use of I/O device 46, in this example to the Switch Control Service (SCS) component 48. A Radio Services System Control Center 50 communicates in this example via ports 52 and 54 having a bidirectional flow of information with ports 56 and 58 of the SCS component 48. Similarly, a Radio Security Services Audit Service Center 60 communicates via its port 62 being coupled to port 64 of the SCS component 48.

The switch 8 supports inerconnection between various I/O and Processor interfaces, as previously mentioned. Each low level interface capable of connecting to a Switch 8 circuit is identified as a port by the Switch Policy 6 and Switch 8. Ports are defined for the purpose of the Switch 8 as:

1. A data connection to any one Processor;

2. An audio connection to any one Processor;

3. Any data connection to user I/O's; and

4. Any audio connection to user I/O's.

The Switch policy 6 provides the Mandatory Access Control (MAC) decision making process. The Switch 8 creates circuit connections among I/O channels or ports, and among Processor channels or ports to permit information flow between objects based upon decisions made by the Switch Policy 6. The Switch circuits are independent of each other and any channel or port can be brought on line without affecting the other channels or ports. The Switch Policy 6 configures one port or channel at a time. In this way, any one circuit can be configured or deactivated without interfering with any other circuit. The active channels and/or ports are not shut down when a new one is brought on line. The switch 8 enforces information flow control policy for the JTR Set.

The Switch 8 and Switch Policy 6 provide interconnections between various combinations of Processors and I/O ports that support information flow policy, thereby restricting interconnections to objects of identical security classification and non-hierarchical category. The Switch 8 and Switch Policy 6 use the concept of ports to provide information flow control between the various objects requiring MAC adjudication.

MSLS Switch Policy Function:

The Switch 8 and Switch Policy 6 provide interconnections between various combinations of Processors and I/O ports that support information flow policy restricting interconnections to objects of identical security classification and non-hierarchical category, as previously mentioned. The Switch Policy 6 determines if System Control Services 50 (See FIG. 3) configuration requests conform to the MAC requirements/security policy.

The Switch Policy 6 provides interfaces with:

1. The Radio Service System Control 50 (resides on the Configuration Generator 4, in this example); and

2. A Security Manager 36.

Classifying Ports and Processors:

The Switch Policy 6 obtains required labels by the following method. The Switch Policy 6 resets the security label locations as part of a startup routine. The System 50 stores the security I/O label file in a mass memory. As part of the startup routine, the System Control 50 (see FIG. 3) forwards a security I/O label file to the Security Manager 36. The Security Manager 36 authenticates the file and loads the Security I/O label file into the Switch Policy 6.

The Security Manager 36 forwards the security label of the Processor to the Switch Policy 6 when the security label changes for the respective Processor.

The Switch Policy 6 uses the Security Manager 36 interface to obtain the security I/O label which provides the sensitivity classification for the various I/O ports and Processors. The Switch Policy 6 uses the security information as the basis for mandatory access control (MAC) decisions.

Switch Circuit Configuration:

The Switch Policy 6 uses the Configuration Generator 4 interface to receive switch configuration requests from the Switch Control Service Component 48. A request to create a switch circuit comes from a configuration file. Trusted paths are created to ensure the request originates from the appropriate object. The Configuration Generator 4 uses a trusted path with the Security Manager 36 to pass Switch configuration requests to the Security Manager 36. The Security Manager 36 relays the Switch configuration request via a trusted path to the Switch Policy 6. The Switch Policy 6 uses the trusted path with the Security Manager 36 to ensure that only trusted objects within Security Manager 36 identify the security label of each Processor and I/O Port.

The Switch Policy 6 permits connections between:

1. Channel Processors; and

2. User I/O ports and/or other channel processors.

The System Control Service 48 initiates a circuit connection with a circuit connection request to the Switch Control Service 48. The Switch Control Service 48 makes the circuit connection request after any Processor initialization. The Switch 8 supports up to N circuits with up to M port connections per circuit. The values of N and M are determined by the particular application. The Switch 8 maintains separate connection registers for each port. The Switch Policy 6 writes to the specific connection register the specific port (I/O or Processor) to be connected.

The following discussion addresses circuit connections requested between user I/O ports and Processors within a system. Once the Switch Policy 6 receives a circuit connection request from the Switch Control Service 48, the Switch Policy 6:

1. Compares the security label from the first port with the security label of the second port to be connected to the circuit;

2. If all security labels are equal (same hierarchical classification, same non-hierarchical compartment), Switch Policy 6 sets the connection registers for the requested circuit, and ACK (positive acknowledge) response to the Switch Control Service 48; and

3. If two ports' security labels are not equal between any other connection requests, then a NACK (negative acknowledge) response is sent to the Switch Control Service 48.

The Switch Policy 6 also limits each Switch port to a single circuit. The Switch Policy 6 provides this limitation to prevent interference between circuits, not for security purposes.

High Assurance Switch Function:

Each circuit has switches, which can connect any two of the ports together subject to the limitations discussed previously.

The Switch 8 treats each Switch port as a single label device. Security label determination is described above under the Switch Policy 6. Unique Switch Connection Registers 12 are associated with each port. Unique inputs and outputs are associated with each port connection register. The Switch 8 asserts the unique port gates (connection made to a specific circuit) when the Switch Policy 6 writes the destination port ID into its Switch Connection Register 12. The Switch 8 only uses circuit switching to facilitate evaluation.

Those skilled in the art will appreciate that the present invention allows MSLS to be implemented with minimal intelligence in Switch Policy 6, and to perform the switching functions with minimized code requiring evaluation.

Essentially with further reference to FIG. 3, the Switch Policy 6 has two components. One is a Switch Control Service Component 48 which is a reference part on the configuration generator 4. The second is the SP (Switch Policy) Component 6,10 which is resident on a microcontroller connected to the Switch 8.

The Radio Services System Control 50, through the SCS 48 interface, is the entity that commands the SP 6 to do all its various functions such as connect a circuit, disconnect a circuit, reset, provide I/O port security label data, etc. The SCS 48 receives the SP 6 command responses and relays the information to Radio Services System Control 50. The Radio Security Services Audit Service (RSSAS) 60 is for reporting auditable events or alarms.

Responses are fed back by the RSSC 50. The communication from the SCS to the SP is through the Security Manager interface layer. The Security Manager for the most part is just a pass through. There is one message that it automatically generates, as will be discussed below in relation to one of the Sequence Diagrams. The method is initiated when the command comes in from Radio Services System Control 50, via the SCS Component 48 going through the assembly of Ethernet Driver 42 through the Security Manager 36. The latter transmits the message over an I²C Interface 38 to the SP Component 48. The SP Component 6,10 maintains numerous tables based on the pertinent data. One table is an I/O Port Security Label Table, containing a list of the I/O Ports and their security labels. Security labels consist of security levels such as secret, classified, confidential, etc., and a compartment label which consists of tags such as US only and/or NATO.

Another table is a circuit connection table of active circuit connections. Yet another table is a JTR port security label table, which is a list of the circuit connections going across two systems. The SP Component 6,10 on one side communicates the I²C 38 to the Security Manager 36 and onto the SCS 48 or SCS System Control 50, and in the other direction communicates with the Switch 8. A Switch ASIC (Application Specific Integrated Circuit) is the Switch Fabric Connection Registers 12. These are the registers that the SP Component 6,10 writes to when it wants to make a connection or make a disconnection. There is another interface there through a Dual Port RAM 32. If the SP component 6,10 wants to communicate with another JTR, it communicates via the Dual Port RAM 32. A Switch SP Message Handler 29 handles the Dual Port RAM 32 on the other side. It communicates via a Mux 26 to another JTR indirectly to another JTR's SP Component 27, or to operator interface devices known as CDD's 34. A local CDD and a remote CDD, and all three of those interfaces are via Mux (multiplexers) 28 and 30.

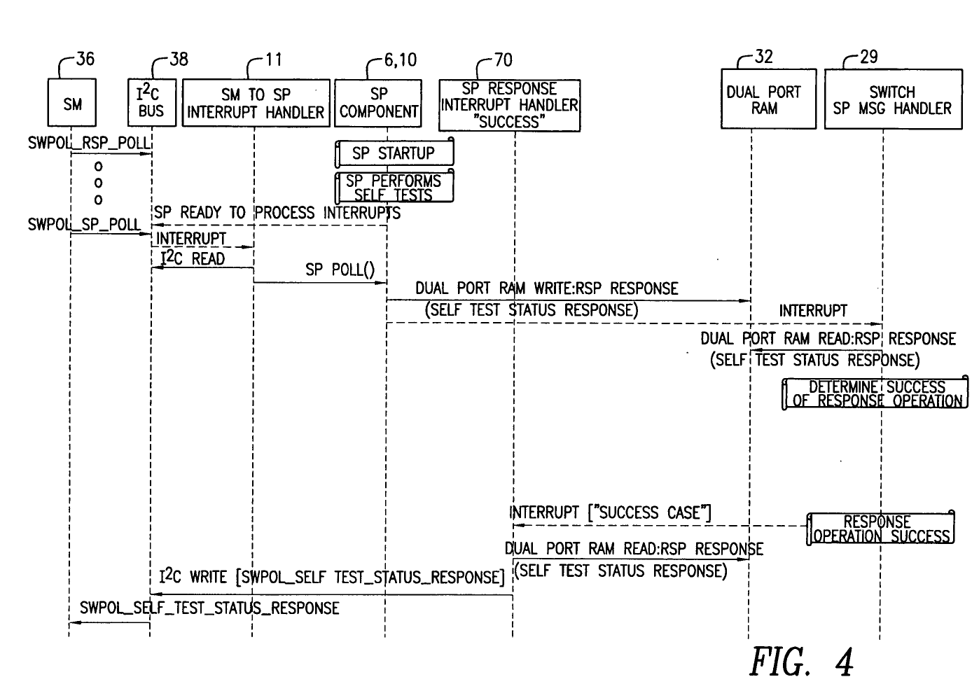

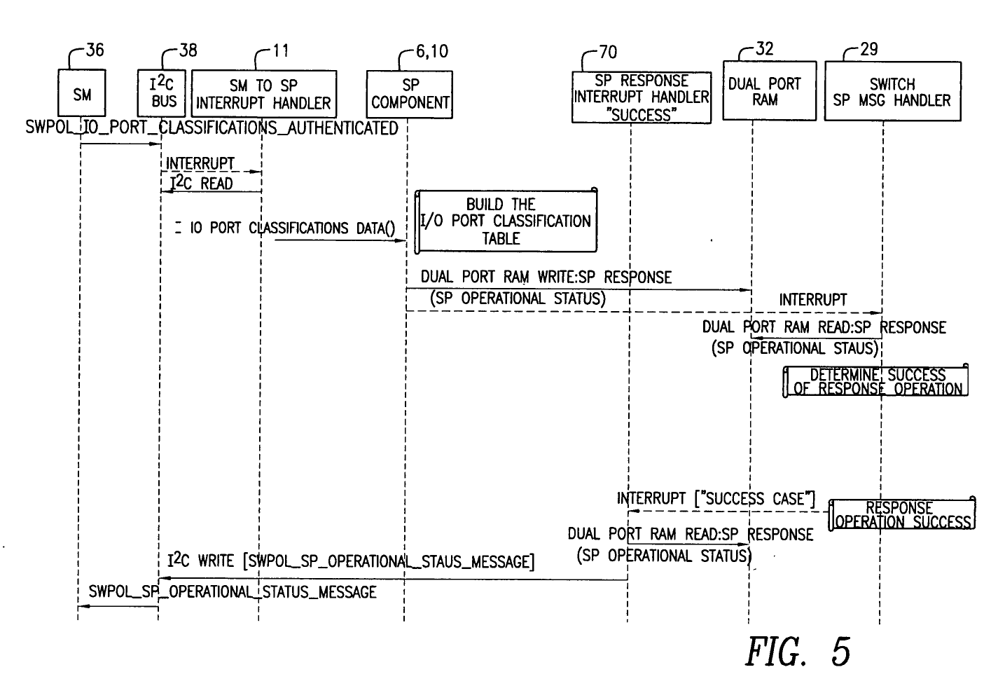

An SP Startup Sequence Diagram is shown in FIG. 4. In this Diagram, and the Sequence Diagrams of FIG. 5 through 9, programming or processing steps, typically progress from left to right and top to bottom. In FIG. 4, the top left side is an SP Poll (Switch Policy Poll) message being received by the Security Manager 36 interface from Ethernet Interface 40 in this example. The signal path in this example is from Radio Services System Control 50, through Switch Control System (SCS) component 48, I/O Device Call 46, Ethernet Driver 42, and Ethernet Interface 40. However, FIGS. 4 through 9, for the sake of simplicity, show programming steps or processing from the Security Manager 36, with the message entering the Security Manager 36 being passed onto the I²C Bus or Ethernet Interface and so forth. At SP startup, the SP Component 6,10 performs a number of self-tests. At the same time there are other portions of the system that are starting up such as the Security Manager 36 System Control, and SCS Component 48, for example. When the SCS Component 48 completes startup, it begins generating Switch Policy SP Poll messages, and will send them out periodically. When the SP Component 6,10 completes startup, it performs self-tests, and if the self-tests are successful, the Security Manager to SP Interrupt Handler 11 is ready to process interrupts, and at that point it will receive an interrupt indicating data on the I²C Bus 38 in the form of a Switch Policy (SWPOL) SP Poll message. The Interrupt Handler 11 next performs an I²C Read. It reads this data, recognizes it as a poll message, and performs the SP Poll processing. The SP Component 6,10 generates a Self-Test Status Response message which it writes to the appropriate memory partition in Dual Port RAM 32. At that point it interrupts the Switch SP Message Handler 29, indicating that there is data in Dual Port RAM 32 that the Message Handler 29 has to read. The Handler 29 will then read the appropriate report RAM location to be the Self-Test Status Response. The SP Message Handler 29 then does a determination as to whether it was successful or not successful. If it determines the response to that operation is a failure, it generates an interrupt. An Alarm Interrupt Handler 70 responds to the interrupt by generating an audit event signal message with an audit event indication via an 12C Write to the I²C Bus 38. If the response operation was successful, an Interrupt is then triggered for the success case, the SP Response Interrupt Handler 72 is triggered, and responds by reading the appropriate Dual Port Memory Partition, reading the Self Test Status Response Message, and performing an I²C write to the Security Manager 36 which sends it up the line eventually getting to Radio Services System Control 50.

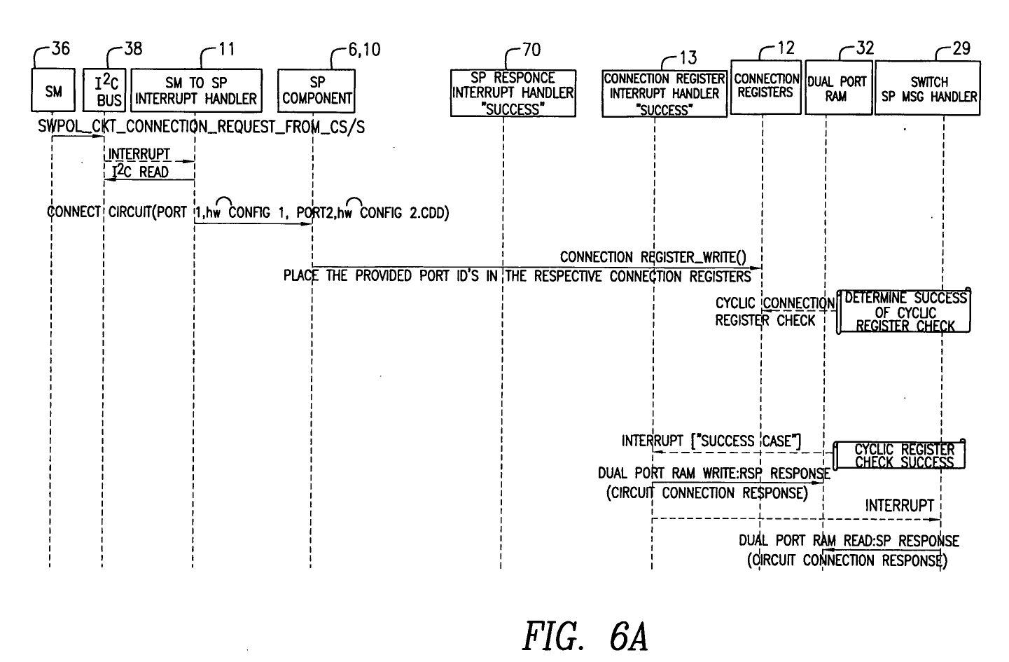

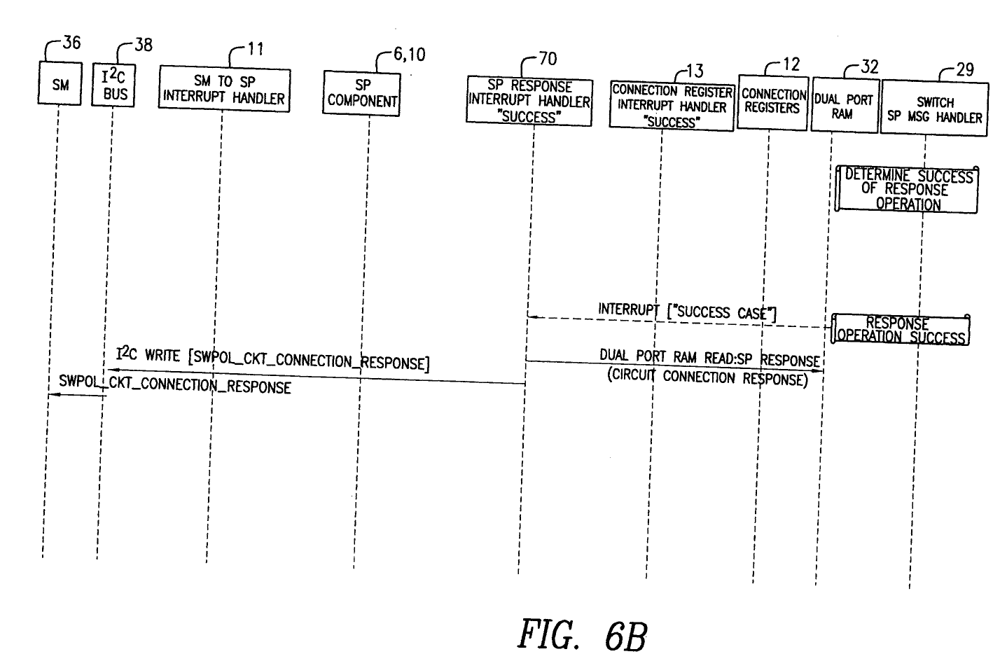

In FIG. 5, an I/O Port Security label Data Sequence Diagram is shown. System Control 50 reads an I/O Port Security label Data file from memory, and sends it via the SCS 48 to the Security Manager 36. The Security Manager 36 authenticates this file, puts it in a message format for the SP Component 6,10, which is a Switch Policy I/O Port Security labels Authenticated Message, and passes it onto the I²C Bus 38. Next, an interrupt is generated, the SP Interrupt Handler 11 receives the interrupt as an I²C Read, reads a routine designated I/O Port Security label Data off the I²C Bus into the SP Component 6,10, and the latter builds and maintains an I/O Port Security label Table based on the data that it received within this message. The data includes all the I/O Ports and their security labels composed of respective security levels and compartment labels. When the SP Component 6,10 processes this message, it will generate a response. The response is an SP Operational Status Message. The message is written to Dual Port RAM 32. Next, an Interrupt is triggered, causing the SP Message Handler 29 on the Switch 8 to respond by reading the appropriate section of Dual Port RAM 32 to retrieve the message. The SP Message Handler 29 determines the success of the response operation, whereby all further processing is similar to that of SP Startup described above, as will be the case for all of the following sequence diagrams of FIGS. 6 through 9 discussed below. If any of these determinations are a failure, an Alarm Signal Message with an Alarm indication is generated, as would happen in this case. More specifically, as with the SP Startup, if failure occurs, an audit event is triggered, an Alarm Signal Message is generated, put on the I²C Bus and sent upstream. If it is a success, an Interrupt is generated for the success case, the SP Response Interrupt Handler 70 is called, and it responds by performing a Read to Dual Port RAM 32. Once the Dual Port RAM 32 Read has been executed, the Interrupt Handler 70 then forwards the Switch Policy SP Operational Status Message, on the I²C Bus 38. The Security Manager 36 retrieves the message off the I²C Bus 38, and passes the message upstream to Radio Services System Control 50.

A Circuit Connection Request Sequence Diagram is shown in FIGS. 6A and 6B. A Circuit Connection Request is detected on the I²C Bus 38 triggering the SP Interrupt Handler 11, which responds by performing an I²C Read, reading the message off the I²C Bus 38, and determines that it is a Circuit Connection Request. Interrupt Handler 11 responds by calling the Connect Circuit routine. The SP Component 6,10 then retrieves the port ID's that are to be connected, and performs a connection Register Write operation. A bank of Connection Registers 12 is included in the Switch 8 (FIGS. 1-3), one register for every port that exists. For example, if Port A is to be connected to Port B, the Switch Connection Registers 12 write Port B address into Port A, and Port A address into Port B, and the Switch SP Message Handler 29 does a Cyclic Connection Register Check to determine if anything was written to the Connection Registers. If a non-zero value was written into the designated Connection Registers 12, it then tries to perform a circuit connection. In performing the Cyclic Connection Register Check, the SP Message Handler 29 determines whether the circuit connection is a failure or success. In the failure case, operation is similar to that performed for the previously described sequence diagram.

In the case of a success, an Interrupt is written to the Connection Register Interrupt Handler 13, which responds by writing a Circuit Connection Response to Dual Port RAM 32, and writing an Interrupt to the SP Message Handler 29 telling the latter that information was written to Dual Port RAM 32. The Message Handler 29 then reads the Circuit Connection Response. The response message is checked. If the operation was deemed a success, a success case will trigger an interrupt that the SP Response Interrupt Handler 70 will respond to by reading the SP Response, which is the Circuit Connection Response. The SP will put the Switch Policy Circuit Connection Response message onto the I²C Bus 38 where it will ultimately pass to System Control 50.

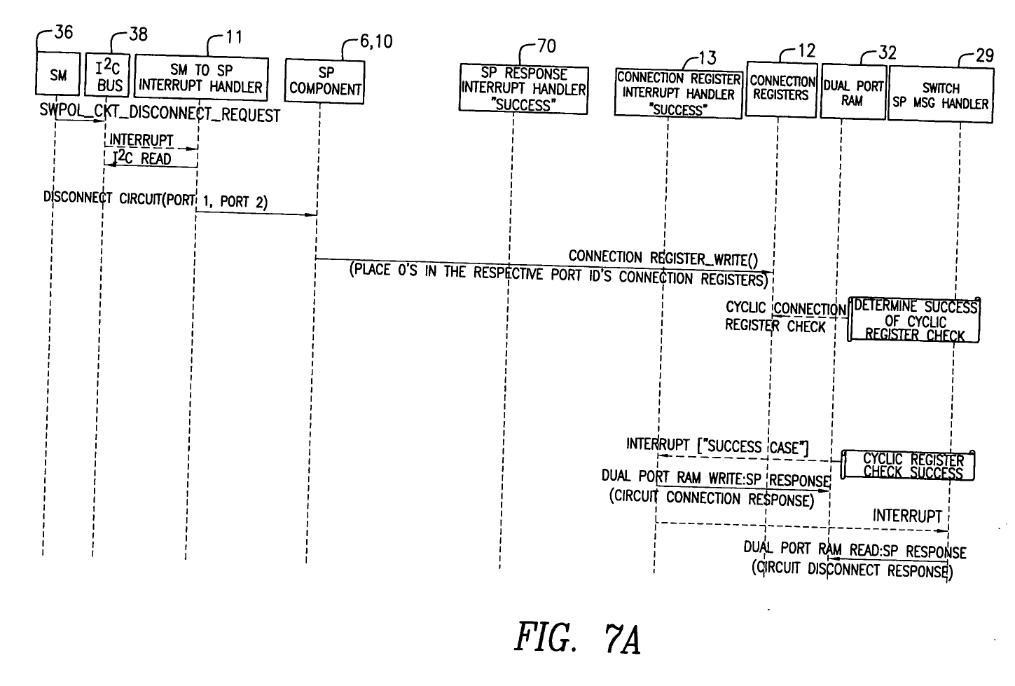

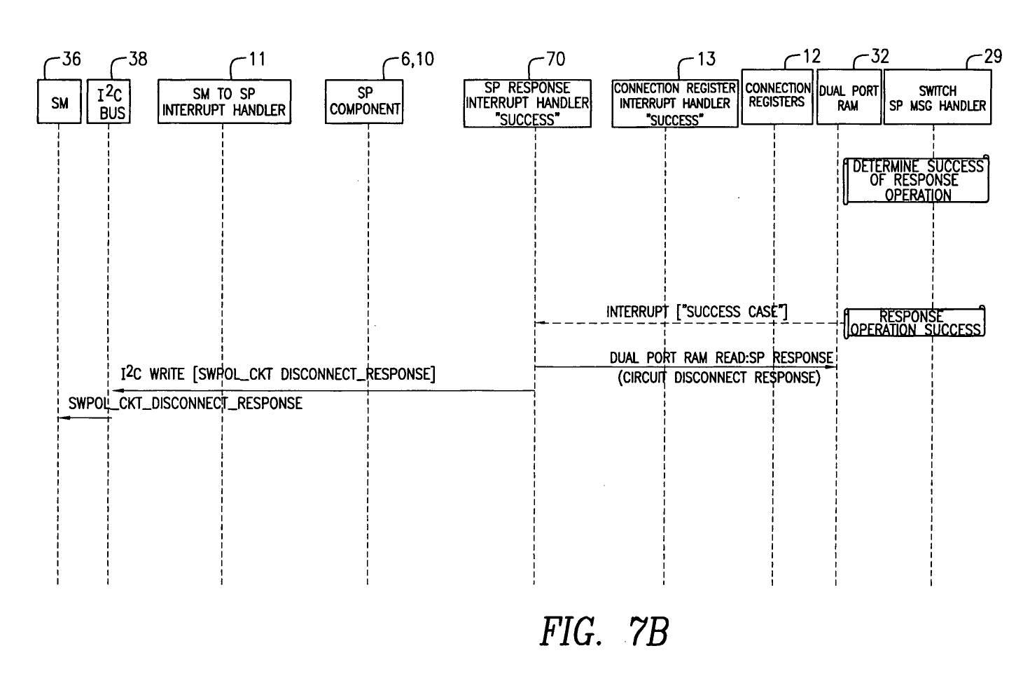

The processing continues with reference to the Circuit Disconnect Request Sequence Diagram of FIGS. 7A and 7B. A Circuit Disconnect Request comes in from System Control 50 96642 16 through the SCS 48 to the Security Manager 36. The request is put on the I²C Bus 38. The Security Manager to SP Interrupt Handler 11 triggers on an interrupt, and generates an I²C Read. It reads the message and determines that it is a Circuit Disconnect Request message. It processes the message and performs a Disconnect Circuit Write. However, in this case, it looks at the two identified Port ID's, for example, Ports A and B, which are supposed to be disconnected. It responds by writing 0 in Port A and B respective Connection Registers 12. Previously for connection the address of Port B was written in Port A's connection register, and the address of Port A into Port B's connection register. A connection register write is performed.

A determination of the success of the Circuit Disconnect Response operation is now made. If the operation is a success, a Success Interrupt is triggered. The SP Response Interrupt Handler 70 reads the Circuit Disconnect Response from Dual Port RAM 32 and puts the message on the I²C Bus 38 to be received by Radio Services System Control 50.

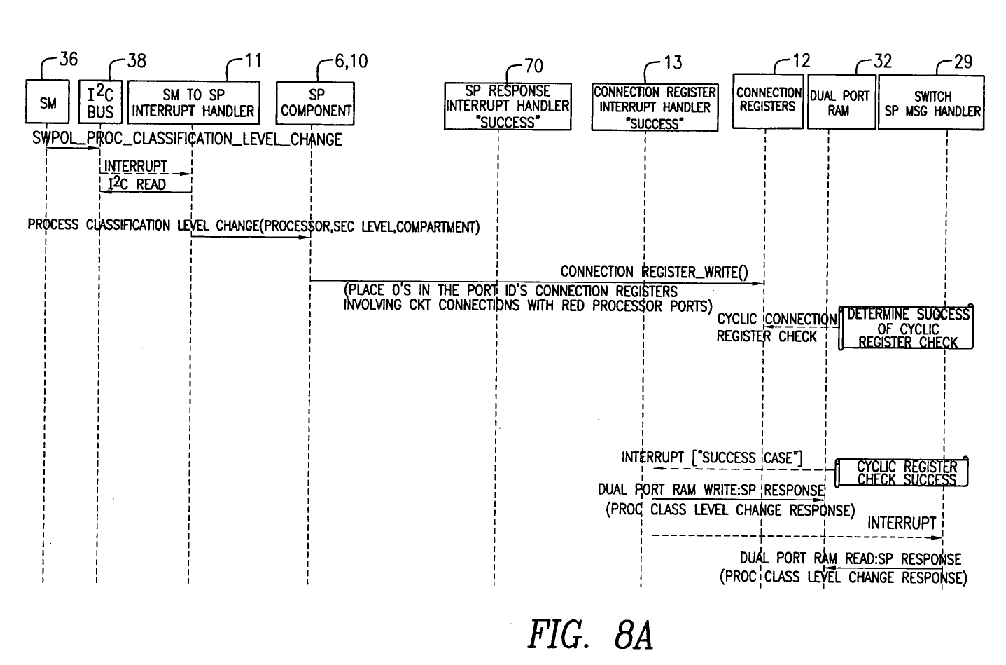

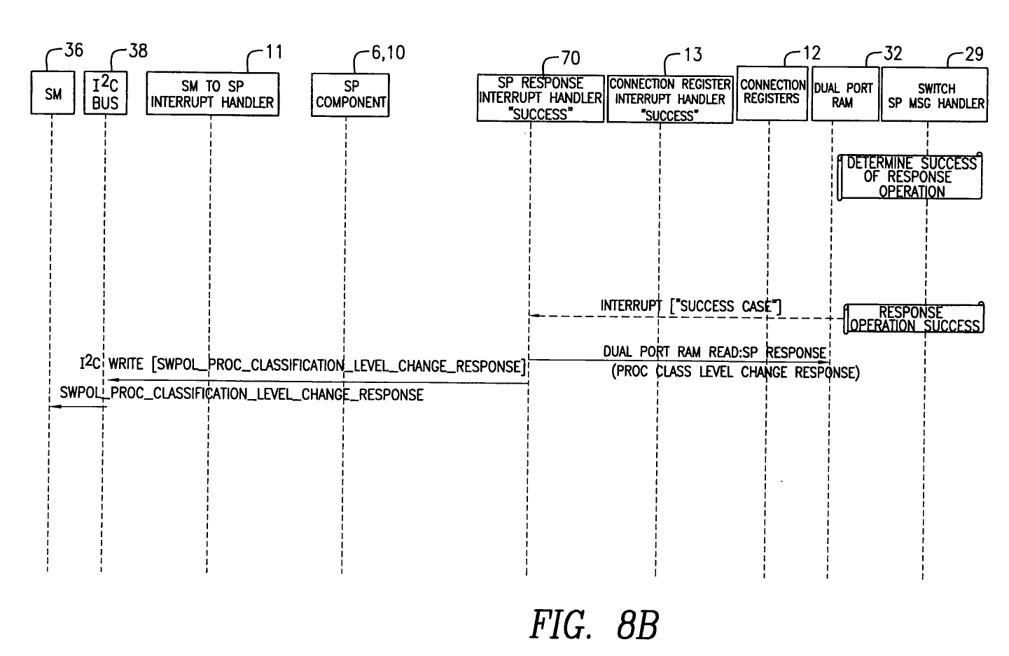

The processing or programming description continues with reference to the Processor Security Label Change Sequence Diagram of FIGS. 8A and 8B. A Processor Level Change message is the one message that is autonomously generated by the Security Manager 36, not by System Control 50. This message gets generated when the Security Manager 36 responds to a processor changing security labels. The Security Manager to SP Interrupt Handler 11 triggers on the interrupt, and performs an 12C Read off the I²C Bus 38. Upon determining that a Processor Security label Change message was read, SP Component 6,10 determines if there is any active circuit connection on the processor that has just changed its classification label. If there is, SP Component 6,10 performs Connection Register Writes on Connection Registers 96642 17 12, disconnecting all active circuit connection involving any one of that processor's ports. The SP Component 6,10 writes zeros in the affected port ID connection registers that have active circuit connections that must be disconnected. After SP Component 6,10 writes to those Connection Registers 12, the Switch 8 performs the circuit disconnections. Next, the SP Message Handler 29 performs a Cyclic Register Check, to determinate the success or failure thereof. If it was successful, SP Message Handler 29 interrupts Connection Interrupt Handler 13, which responds by generating a Processor Security Label Change Response message, which it writes to Dual Port RAM 32. It interrupts the SP Message Handler 29 to indicate that there is a message to be read. The SP Message Handler 29 responds by reading the Processor Security label Change Response message, and then does a determination of the success or failure of that response operation. If the response operation was successful, the Switch Message Handler 29 triggers an interrupt for the Success Case, whereby the SP Response Interrupt Handler 70 is executed, and responds by reading the Processor Security label Change Response message from Dual Port RAM 32, and writing the message to the I²C Bus 38, for ultimate reception by System Control.

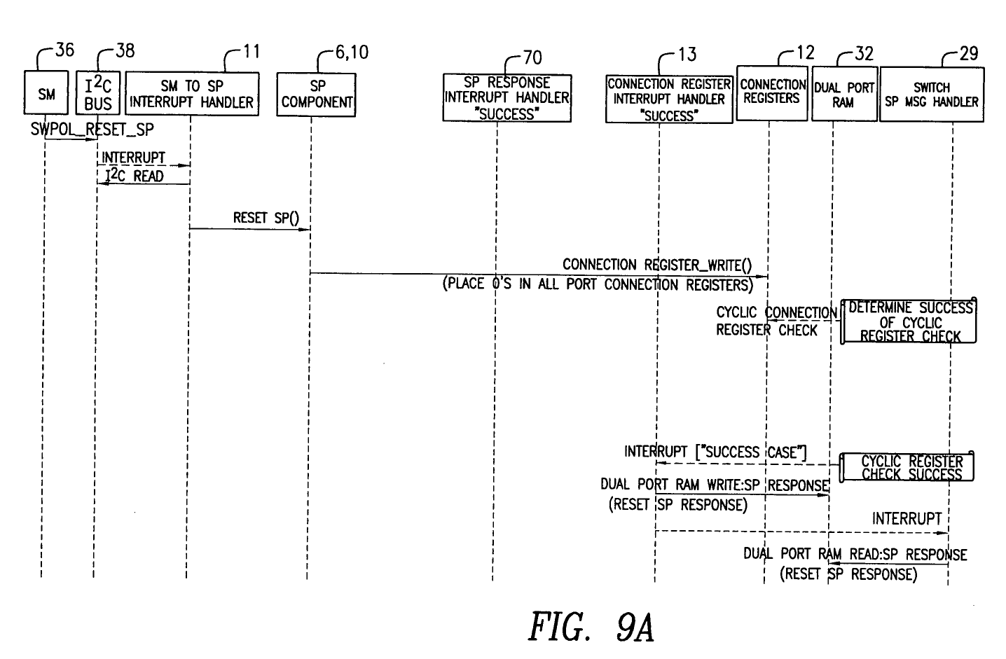

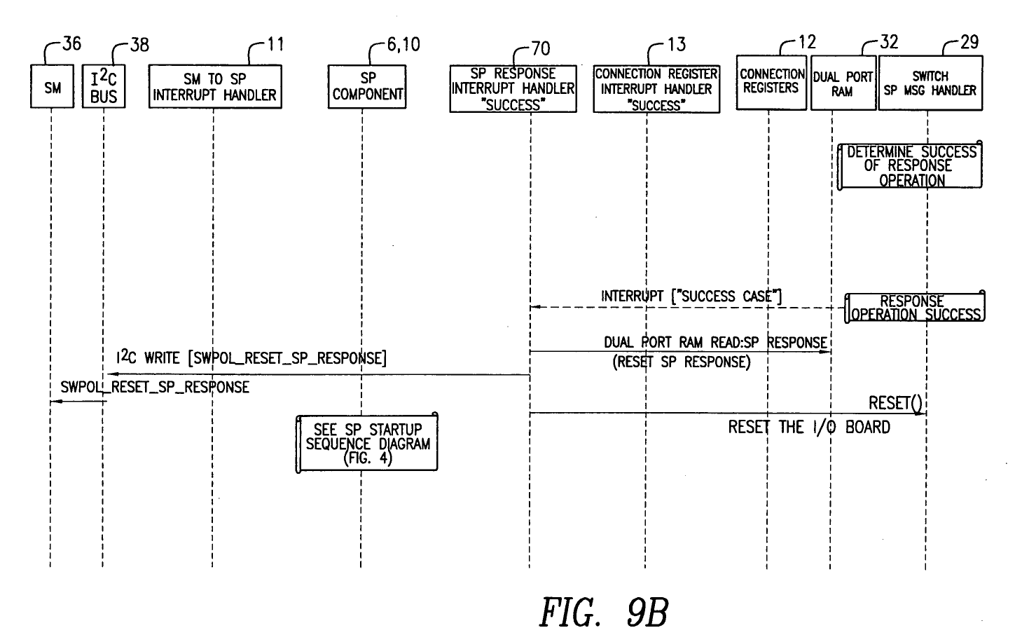

Reference is now made to the Reset SP Sequence Diagram, shown in FIGS. 9A and 9B. Due to various conditions, System Control 50 might decide to reset the SP 6. At that time a command will be generated from System Control 50 to initiate the reset. The command goes through the SCS Component 48, as do all the other commands, through to the Security Manager 36. Eventually the command will be placed on the I²C Bus 38, an Interrupt is generated to the Security Manager 36 to SP Interrupt Handler 11, which responds by generating an I²C Read, reads the message off the I²C Bus 38, and determines that it is a Reset SP. SP Interrupt Handler 11 performs the Reset SP processing by sending a Reset SP( ) to SP Component 6,10 which responds by generating a Connection Register Write( ) for writing all zeros in all the port connections affected. In this manner all ports are disconnected any channels.

Following this step, as previously described for the other sequences, the success or failure of the Reset must be determined. If it is a success case, as before, a response message is generated, and a Reset SP Response message is generated by Connection Register Interrupt Handler 13 and written to the Dual Port RAM 32. Also, an interrupt is triggered by Interrupt Handler 13 to activate the Switch Message Handler 29 to read from the Dual Port RAM 32 memory address which contains the Reset SP Response message.

Next, as shown in FIG. 9B, a determination of the success of reading Reset SP Response must be made. The success case will trigger the Interrupt Success Case to the SP Response Interrupt Handler 70, the latter responding by reading the Reset SP Response to Dual Port RAM 32, and also writing the Reset SP Response on the I²C Bus 38, via an I²C Write, for transfer upstream to System Control 50, as previously described for other Sequences. Next, the SP Response Handler 70 generates a reset command for resetting the SP 6 and the Switch 8. After resetting, a new Startup Sequence can be initiated as described above for the SP Startup Sequence Diagram, of FIG. 4.

In summary, note that there are six messages in the Sequence Diagrams in FIGS. 4 through 9A and 9B that all have the same type of steps. When a message is received, an operator determines the message content, an operation is performed, validation of that operation is made to determine success or failure

Although various embodiments of the invention have been shown and described herein, they are not meant to be limiting. Those of skill in the art may recognize certain modifications to these embodiments, which modifications are meant to be covered by the spirit and scope of the appended claims.

What is claimed is:

1. A security system providing multiple single levels of security (MSLS) for associated apparatus, each of said associated apparatus including a respective plurality of ports and/or channels, and wherein said security system comprises:
label assignor means for assigning security labels to respective ones of said plurality of ports and/or channels of said associated apparatus;
programmable configuration generator means for requesting an interconnection of selected ports and/or channels of a first associated apparatus with specific designated ports and/or channels of a second associated apparatus for effecting communication therebetween;
switch policy means responsive to the port and/or channel security label assignments from said label assignor means, and port and/or channel interconnections requested by said programmable configuration generator, for both permitting only those ports and/or channels meeting both hierarchical and non-hierarchical label based mandatory access control requirements to be retained in the requested interconnection, and notifying said configuration generator means of the ports and/or channels denied interconnection; and
switching means responsive to said switch policy means for interconnecting only those ports and/or channels meeting both hierarchical and non-hierarchical label based mandatory access control requirements.

2. The security system of claim 1 wherein said label assignor means is programmed to include the assigned security labels of said plurality of ports and channels.

3. The security system of claim 1 wherein said programmable configuration generator means is programmed to include a requested configuration.

4. The security system of claim 1 wherein said programmable configuration generator means is responsive to configuration information received from remotely located devices including personal computers.

5. The security system of claim 1 wherein said switching means includes a plurality of switch fabric connection registers operable for electrically connecting an individual one of said plurality of ports and channels together.

6. The security system of claim 5 wherein said switch fabric connection registers are provided by an application specific integrated circuit (ASIC).

7. The security system of claim 5 wherein said switch fabric connection registers support N communication circuits and M port connections per circuit, whereby the values of N and M are application dependent.

8. The security system of claim 7 wherein respective ones of said plurality of switch fabric connection registers are associated with individual ones of said N communication circuits.

9. The security system of claim 5 wherein said plurality of ports and/or channels individually are designated to provide either one of a data connection, or an audio connection, to an associated user or apparatus in said system.

10. The security system of claim 1 wherein said switch policy means is operative to enforce hierarchical and/or non-hierarchical mandatory access control for said plurality of ports and channels in the requested interconnection.

11. The security system of claim 1 further including:
means for individually providing bidirectional communication between said switch policy means and a plurality of ports.

12. The security system of claim 11 wherein said bidirectional communication providing means includes:
first through third interface circuits (Ifc's) each having an individual connection to said switch policy means; and
first through third MUX devices individually connected between said first Ifc and a JTR, said second Ifc and a local CDD, and said third Ifc and a remote CDD, respectively.

13. The security system of claim 1 wherein said switch policy means further includes means for making a one-to-one association between labels or assignments received from said label assignor means and port and channel interconnections requested by said configuration generator means.

14. The security system of claim 1 wherein said switch policy means and said switching means in combination provide a means for enforcing a mandatory access control (MAC) policy for MSLS.

15. The security system of claim 1 wherein said programmable configuration generator means is further operative for requesting the deactivation of selected ports and/or channels of said first and second associated apparatus, respectively.

16. The security system of claim 15 wherein said switch policy means operates said switching means for interconnecting or deactivating one of said plurality of ports and/or channels at a time, thereby preventing interference with other switching circuits of the associated apparatus.

17. The security system of claim 1 wherein said configuration generator means includes:
authentication means for authenticating an associated configuration file as being received from a trusted source; and
a Security Manager for authenticating I/O security labels from said authentication means, forwarding an I/O security label file to the label assignor means for authentication, marking the file as being authenticated, and passing the file to said switch policy means.

18. The security system of claim 1 wherein said switch policy means includes:
an input/output (I/O) port/channel security label table developed from information received from said label assignor means and said configuration generator means, said table showing the security labels assigned to said plurality of ports and/or channels; and
a circuit connection table showing active circuit connections between said plurality of ports and/or channels.

19. The security system of claim 18, wherein said switch policy means further includes a table for system security labels showing circuit connections between a plurality of systems.

20. A method for providing multiple single levels of security (MSLS) for associated apparatus, each of said associated apparatus including a respective plurality of ports and/or channels, said method comprising the steps of:
assigning security labels to respective ones of said plurality of ports and/or channels of said associated apparatus;
requesting the interconnection of selected ones of said plurality of ports and/or channels of said associated apparatus;
determining which of the selected ones of said plurality of ports and/or channels have compatible security labels; and
interconnecting only those ports and/or channels determined to have compatible security labels;
wherein said determining and interconnecting steps in combination provide for enforcing a hierarchical and non-hierarchical, label-based mandatory access control (MAC) policy for MSLS.

21. The method of claim 20 wherein said interconnecting step further includes only connecting one circuit of said plurality of ports and/or channels at a time.

22. The method of claim 20 wherein said determining step includes the step of communicating the ones of said plurality of ports and/or channels having compatible security labels to a plurality of devices including a Joint Tactical Radio (JTR), a local CDD and a remote CDD.

23. The method of claim 22 wherein said communicating step is made via a plurality of multiplexers (MUX's) to said plurality of devices, respectively.

24. The method of claim 20 wherein said determining step is responsive to said assigning step and said requesting step for individually making a one to one association between the assigned security labels of each one of said plurality of ports and/or channels respectively requested to be interconnected.

25. The method of claim 20 further including the step of configuring said plurality of ports and/or channels to each provide either one of a data connection or an audio connection to an associated user or apparatus in said system.

26. The method of claim 20, wherein said requesting step further includes the step of designating selected ones of said ports and/or channels, that are presently active, to be deactivated.

27. The method of claim 20 wherein said requesting step further includes the steps of:
authenticating an associated label file as being received from a trusted source; and
blocking use of label files not received from a trusted source.

28. The method of claim 20 wherein said determining step further includes the steps of:
developing an I/O port/channel security label table showing the security labels assigned to each one of said plurality of ports and/or channels; and
developing a circuit connection table showing active circuit connections between said plurality of ports and/or channels.

29. The method of claim 28 wherein said determining step further includes the step of:
developing a table for system classification showing circuit connections between a plurality of systems.
